(19) United States
(12) Patent Application Publication
(10) Pub. No.: US 2009/0238150 A1
(43) Pub. Date: Sep. 24, 2009

(54) HIGH SPEED DOWNLOAD PACKET ACCESS COMMUNICATION IN A CELLULAR COMMUNICATION SYSTEM

(75) Inventor: Stephen John Barrett, Berkshire (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/297,697

(22) PCT Filed: Mar. 20, 2007
(86) PCT No.: PCT/US07/64348

§ 371 Date: Oct. 20, 2008

(30) Foreign Application Priority Data
Apr. 27, 2006 (GB) 0608539.3

(51) Int. Cl. H04B 7/216

(52) U.S. Cl. 370/335

(57) ABSTRACT

A cellular communication system supports High Speed Downlink Packet Access (HSDPA) services. A first transceiver (201) transmits HSDPA downlink packet data in a first cell and a second transceiver (203) transmits HSDPA downlink packet data in a second cell. A cell overlap processor (205) can determine that a remote station (101) is in a cell overlap region between the first cell and the second cell. A macro-diversity controller (207) causes the first transceiver (201) to transmit first HSDPA data to the remote station (101) as a first signal in the first cell and the second transceiver (203) to transmit the first HSDPA data to the remote station (101) as a second signal in the second cell. The first and second signals are macro-diversity signals. The remote station (101) comprises a macro-diversity combiner (303) which receives the first downlink HSDPA packet data by combining the first signal and the second signal. The invention may allow improved support of HSDPA services in cell overlap areas.

### FIELD OF THE INVENTION

The invention relates to a high speed downlink packet access communication in a cellular communication system and in particular to support of remote stations in a cell overlap region.

### BACKGROUND OF THE INVENTION

Currently, the most ubiquitous cellular communication system is the 2nd generation communication system known as the Global System for Mobile communication (GSM). Further description of the GSM TDMA communication system can be found in ‘The GSM System for Mobile Communications’ by Michel Mouly and Marie Bernadette Pautet, Bay Foreign Language Books, 1992, ISBN 2950719007.

3rd generation systems have recently been rolled out in many areas to further enhance the communication services provided to mobile users. One such system is the Universal Mobile Telecommunication System (UMTS), which is currently being deployed. Further description of CDMA and specifically of the Wideband CDMA (WCDMA) mode of UMTS can be found in ‘WCDMA for UMTS’, Harri Holma (editor), Antti Toskala (Editor), Wiley & Sons, 2001, ISBN 0471486876. The core network of UMTS is built on the use of SGSNs and GGSNs thereby providing commonality with GPRS.

3rd generation cellular communication systems have been specified to provide a large number of different services including efficient packet data services. For example, downlink packet data services are supported within the 3^{rd} Generation Partnership Project (3GPP) release 5 Technical Specifications in the form of the High Speed Downlink Packet Access (HSDPA) service.

In accordance with the 3GPP specifications, the HSDPA service may be used in both Frequency Division Duplex (FDD) mode and Time Division Duplex (TDD) mode.

In HSDPA, transmission code resources are shared amongst users according to their traffic needs. The base station (also known as the Node-B for UMTS) is responsible for allocating and distributing the HSDPA resources amongst the individual calls. In a UMTS system that supports HSDPA, some of the code allocation is performed by the RNC whereas other code allocation, or more specifically, scheduling is performed by the base station. Specifically, the RNC allocates a set of resources to each base station, which the base station can use exclusively for high speed packet services. The RNC furthermore controls the flow of data to and from the base stations. However, the base station is responsible for scheduling HS-DSCH (High Speed-Downlink Shared CHannel) transmissions to the mobile stations that are attached to it, for operating a retransmission scheme on the HS-DSCH channels, for controlling the coding and modulation for HS-DSCH transmissions to the mobile stations and for transmitting data packets to the mobile stations.

HSDPA seeks to provide packet access techniques with a relatively low resource usage and with low latency.

Specifically, HSDPA uses a number of techniques in order to reduce the resource required to communicate data and to increase the capacity of the communication system. These techniques include Adaptive Coding and Modulation (AMC), retransmission with soft combining and fast scheduling performed at the base station.

Although 3rd Generation cellular communication systems support soft handovers wherein transmissions between a mobile station and a plurality of base stations are combined for improved performance, HSDPA communications are designed to involve only a single cell in order to allow the serving base station to have efficient and fast control of the communication. Accordingly, HSDPA relies on only a single radio link.

Standardisation activities are currently undertaken to further enhance the services provided by HSDPA. Specifically, there is a 3GPP Release 7 work item aimed at supporting conversational services over HSDPA. This work has centred on the main problem area of improving performance for conversational services on HSDPA for mobile stations in handover regions. In particular, the current Release 5 approach can result in packets being discarded at the source base station with no mechanism being available to recover those packets (the otherwise used approach of Radio Link Control—Acknowledged Mode (RLC AM) is not an option for conversational services as the inherent delays are unacceptable). In addition, there is a more generic problem of the mobile stations experiencing poor Quality of Service (QoS) and possible call drop at cell edges.

Some suggestions have been proposed to overcome this problem. However, most of the proposals that have been put forward are based on speeding up the handover process, for example by pre-configuration of the base stations and the mobile stations, and by-passing involvement of a Radio Network Controller (RNC) for intra-Node B handovers. However, simply speeding up the handover process may not be an adequate approach for mobile stations that are at the cell edge and which may be slow moving. For these mobile stations, it may be the case that neither the serving cell or a target cell is adequate all the time since there may be large variations in signal to noise ratios as a function of time due to fading and changing interference conditions, and there may therefore be some alternation between which cell is the best cell at any given time. Furthermore, for the current Release 5 HSDPA design and the proposed enhancements, the stricter delay requirements for conversational services may mean that there may not be adequate time to wait for an “upfade” to occur before scheduling packets (particularly if the mobile station is moving slowly, since fading coherence time also lengthens as speed decreases).

A related well known concept is the idea of fast cell selection. In this scheme, packets are buffered at multiple base stations and the mobile station indicates which cell is the best at any one moment and packets are then scheduled from that best cell. This has the disadvantage that there is still some latency in the cell change process which can impact QoS. Since the technique relies on Layer 1 signalling there is also a danger that the base sites do not receive the handover information correctly and that the network and mobile station lose synchronisation in terms of their respective conceptions of which base site is the serving base site. Thus, there are more protocol complexities.

Hence, an improved system for HSDPA communication would be advantageous and in particular a system that provides improved support for remote stations in cell overlap regions.

### SUMMARY OF THE INVENTION

Accordingly, the Invention seeks to preferably mitigate, alleviate or eliminate one or more of the above mentioned disadvantages singly or in any combination.

According to a first aspect of the invention there is provided a cellular communication system comprising: first transmitting means for transmitting HSDPA downlink packet data in a first cell; second transmitting means for transmitting HSDPA downlink packet data in a second cell; means for determining that a remote station is in a cell overlap region between the first cell and the second cell; control means for causing the first transmitting means to transmit first HSDPA data to the remote station as a first signal in the first cell and the second transmitting means to transmit the first HSDPA data to the remote station as a second signal in the second cell, the first and second signals being macro-diversity signals; and the remote station comprising combining means for receiving the first downlink HSDPA packet data by combining the first signal and the second signal.

The invention may allow improved performance for HSDPA services and may in particular allow improved support of remote stations in cell overlap regions. The invention may allow a practical implementation and/or low complexity operation.

The first or second cell may be a serving cell for the remote station and the other cell may be a non-serving cell supporting the HSDPA communication in soft handover. The first HSDPA data may be transmitted on the HS-DSCH (High Speed—Downlink Shared CHannel) of the first and second cell. When the remote station is not in the cell overlap region, the first HSDPA data may be transmitted only in one cell.

The cellular communication system may be a 3^{rd} generation cellular communication system and may in particular be a UMTS cellular communication system.

According to an optional feature of the invention, the remote station is arranged to receive allocation assignments from only one of the first and second transmitting means.

This may allow improved performance and/or facilitate operation. The feature may reduce the signalling requirements in many embodiments.

According to an optional feature of the invention, the remote station is arranged to decode the High Speed—Shared Control CHannel, HS-SCCH, of only one of the first transmitting means and the second transmitting means.

This may allow improved performance and/or facilitate operation. The feature may reduce the signalling requirements in many embodiments and/or may reduce complexity of the remote station.

According to an optional feature of the invention, the first HSDPA data is data of a High Speed—Shared Control CHannel, HS-SCCH.

This may allow improved performance and/or facilitate operation. The HS-SCCH may in some embodiments be transmitted using macro-diversity operation. The HS-SCCH information may thus be transmitted by the first and second transmitting means and the received signals combined in the receiver.

According to an optional feature of the invention, the first transmitting means and the second transmitting means are part of a first base station.

This may allow improved performance and/or facilitate operation. The feature may reduce the signalling requirements in many embodiments. The invention may allow improved performance by use of intra-base station soft handover.

According to an optional feature of the invention, the cellular communication system further comprises means for frame synchronising at least one downlink channel of the first and second transmitting means used for transmissions to the remote station.

This may allow improved performance and/or facilitate operation. The feature may reduce the signalling requirements in many embodiments. In particular, this may allow facilitated operation and/or reduced complexity of the remote station.

According to an optional feature of the invention, the at least one downlink channel comprises a downlink channel selected from the group consisting of:—the High Speed—Shared Control CHannel, HS-SCCH; and—the High Speed—Downlink Shared CHannel, HS-DSCH.

This may allow improved performance and/or facilitate operation. The feature may reduce the signalling requirements in many embodiments. The feature may allow improved performance while allowing compatibility with existing HSDPA approaches.

According to an optional feature of the invention, the first and second transmitting means is arranged to use the same channelisation code for the High Speed—Downlink Shared CHannel, HS-DSCH.

This may allow improved performance and/or facilitate operation. The feature may reduce the signalling requirements in many embodiments. In particular, this may allow facilitated operation and/or reduced complexity of the remote station.

According to an optional feature of the invention, the remote station comprises means for determining a receive quality indication for the first HSDPA data in response to a combination of a received pilot signal of the first cell and a received pilot signal of the second cell.

This may allow improved performance and/or facilitate operation. In particular, it may allow a receive quality indication that provides a more accurate reflection of the quality experienced. The combination may be a macro-diversity combining. The pilot signals may be a signal of a Common PIlot CHannel, CPICH, or a Primary Common PIlot CHannel, P-CPICH. The receive quality indication may be a Channel Quality Indication (CQI).

According to an optional feature of the invention, the first transmitting means is part of a first base station and the second transmitting means is part of a second base station.

This may allow improved performance and/or facilitate operation. The invention may allow improved performance by use of inter-base station soft handover.

According to an optional feature of the invention, the control means is part of a Radio Network Controller which comprises means for transmitting the first HSDPA data to both the first base station and the second base station when the remote station is in the cell overlap region.

This may allow improved performance and/or facilitate operation. The Radio Network Controller (RNC) may be a common RNC supporting the first and second base station

According to an optional feature of the invention, the control means is arranged to communicate a transmission time for the first signal to the first base station.

This may allow an efficient way of synchronising transmissions from different base stations. Specifically, the transmission time may be indicated as a frame in which the transmission is to be performed and may be communicated in an HS-DSCH Frame Protocol (FP). The control means may also be arranged to communicate a transmission time for the second signal to the second base station.

According to an optional feature of the invention, the control means is arranged to communicate a transmit frame offset between the first and second base station to at least one of the first and second base station.

This may allow an efficient way of synchronising transmissions from different base stations. Specifically, the transmit frame offset may be transmitted to the non-serving base station or may e.g. be transmitted to both base stations.

According to an optional feature of the invention, the control means is arranged to communicate a channelisation code for the first signal to the first base station.

This may allow an efficient way of allowing different base stations to use the same channelisation code thereby allowing a reduced complexity of the remote station. The control means may also be arranged to communicate a channelisation code for the second signal to the second base station.

According to an optional feature of the invention, the control means is arranged to allocate code resource of a code resource pool reserved for HSDPA macro-diversity transmissions.

This may allow improved performance and/or facilitate operation.

According to an optional feature of the invention, the cellular communication system further comprises means for suspending a retransmission scheme when the remote station is in the cell overlap region.

This may allow improved performance and/or facilitate operation.

According to an optional feature of the invention, the cellular communication system further comprises means for transmitting an indication to the remote station that the remote station is in the cell overlap region and wherein the combining means is arranged to combine the first signal and the second signal in response to the indication.

This may allow improved performance and/or facilitate operation.

According to another aspect of the invention, there is provided a base station for a cellular communication system, the base station comprising: first transmitting means for transmitting HSDPA downlink packet data in a first cell; second transmitting means for transmitting HSDPA downlink packet data in a second cell; means for determining that a remote station is in a cell overlap region between the first cell and the second cell; and control means for causing the first transmitting means to transmit first HSDPA data to the remote station as a first signal in the first cell and the second transmitting means to transmit the first HSDPA data to the remote station as a second signal in the second cell, the first and second signal being macro-diversity signals.

According to another aspect of the invention, there is provided a remote station for a cellular communication system, the remote station comprising: first receiving means for receiving HSDPA downlink packet data in a first cell; second receiving means for receiving HSDPA downlink packet data in a second cell; and the remote station comprising means for receiving first downlink HSDPA packet data by combining a first signal comprising the first HSDPA data transmitted to the remote station in the first cell and a second signal comprising the first HSDPA data transmitted to the remote station in the second cell, the first and second signals being macro-diversity signals.

According to another aspect of the invention, there is provided a method of communication in a cellular communication system, the method comprising: transmitting HSDPA downlink packet data in a first cell; transmitting HSDPA downlink packet data in a second cell; determining that a remote station is in a cell overlap region between the first cell and the second cell; causing the first transmitting means to transmit first HSDPA data to the remote station as a first signal in the first cell and the second transmitting means to transmit the first HSDPA data to the remote station as a second signal in the second cell, the first and second signals being macro-diversity signals; and at the remote station receiving the first downlink HSDPA packet data by combining the first signal and the second signal.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a cellular communication system in accordance with some embodiments of the invention;

FIG. 2 illustrates an example of a base station in accordance with some embodiments of the invention; and

FIG. 3 illustrates an example of a remote station in accordance with some embodiments of the invention.

### DETAILED DESCRIPTION OF SOME EMBODIMENTS OF THE INVENTION

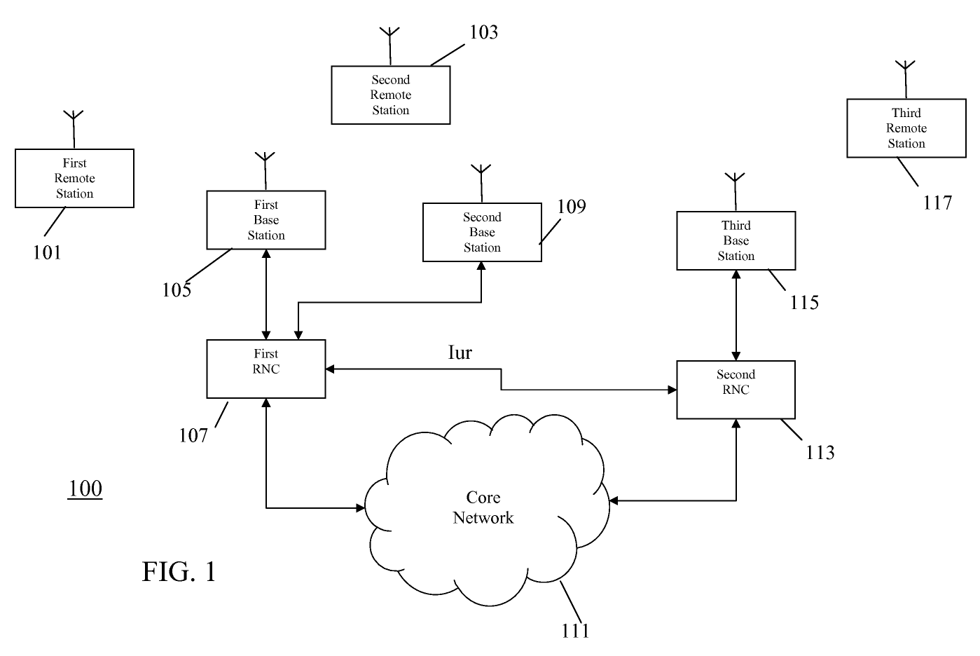

FIG. 1 illustrates an example of a UMTS cellular communication system in accordance with some embodiments of the invention.

In a cellular communication system, a geographical region is divided into a number of cells each of which is served by a base station. The base stations are interconnected by a fixed network which can communicate data between the base stations. A remote station (e.g. a User Equipment (UE) or a mobile station) is served via a radio communication link by the base station of the cell within which the remote station is situated.

In the example of FIG. 1, a first remote station 101 and a second remote station 103 are in a first cell supported by a first base station 105.

The first base station 105 is coupled to a first RNC 107 which is further coupled to a second base station 109. An RNC performs many of the control functions related to the air interface including radio resource management and routing of data to and from appropriate base stations.

The first RNC 107 is coupled to a core network 111. A core network interconnects RNCs and is operable to route data between any two RNCs, thereby enabling a remote station in a cell to communicate with a remote station in any other cell. Typically, a cellular communication system may include a connection (known as an Iur connection) between RNC's for support of macro-diversity combining between base sites that are served by different RNC's.

A core network typically comprises gateway functions for interconnecting to external networks such as the Public Switched Telephone Network (PSTN), thereby allowing remote stations to communicate with landline telephones and other communication terminals connected by a landline. Furthermore, the core network comprises much of the functionality required for managing a conventional cellular communication network including functionality for routing data, admission control, resource allocation, subscriber billing, remote station authentication etc.

The core network 111 is further coupled to a second RNC 113 which is coupled to a third base station 115. The third base station 115 supports a third remote station 117.

In the specific example of FIG. 1, the base stations 105, 109, 113 all support HSDPA services for the remote stations 101, 103, 117. Furthermore, the base stations 105, 109, 113 are capable of detecting when a remote station is in a cell overlap region and are operable to modify the HSDPA operation in such cases. Specifically, the base stations 105, 109, 113 are arranged to deviate from the conventional HSPDA operation which is based on each remote station being supported by only a single base station to using macro-diversity downlink transmissions to support the remote stations in the cell overlap region. This allows a better QoS to be experienced by the remote stations and may in particular provide more reliable and/or lower delay communications. Such performance is particularly important for conversational services and the modified HSDPA operation thus provides an improved support for conversational services.

For clarity and brevity, the described example includes functionality in the base stations for detecting when a remote station is in a cell overlap region. However, it will be appreciated that in other embodiments such functionality may reside in the RNC. Specifically, the RNC can determine whether a remote terminal is in the overlap region. In such embodiments, the RNC may thus be in control of whether or not the remote station is served in a macro-diversity HSDPA configuration. This may be suitable for many e.g. UMTS communication systems where RRC (Radio Resource Control) signalling terminates/is generated in/by the RNC.

The diversity technique applied for HSDPA remote stations in critical areas comprises transmitting two or more signals to the remote station UE from different cells. The cells may be different cells of the same base station and/or may be cells supported by different base stations. For clarity and brevity, the following description will focus on the macro-diversity techniques being based on transmissions in multiple cells supported by the same base station.

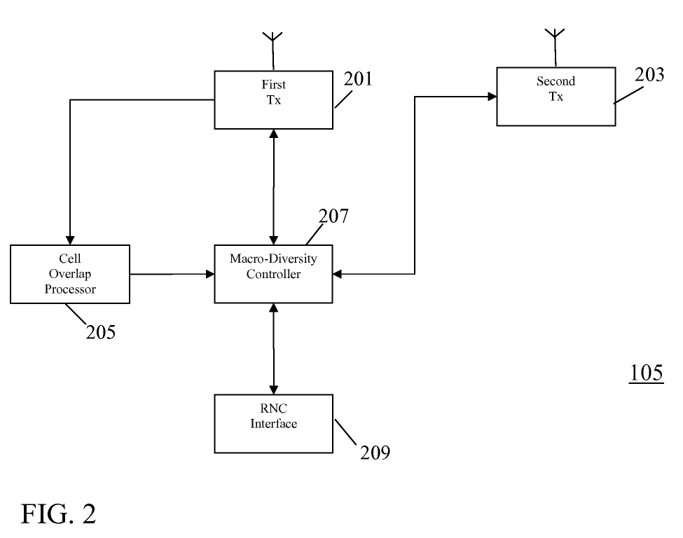

FIG. 2 illustrates an example of elements of the first base station 105.

The first base station 105 comprises a first transceiver 201 which supports remote stations in a first cell. The first base station 105 furthermore comprises a second transceiver 203 which supports remote stations in a second cell. The first and second cell may for example be created by the use of directional antennas pointing in different directions from the base station site.

Specifically, the first transceiver 201 and the second transceiver 203 support HSDPA services in the first and second cell respectively. Thus the first transceiver 201 transmits HSDPA downlink packet data in the first cell and the second transceiver 203 transmits HSDPA downlink packet data in the second cell.

The first base station 105 furthermore comprises a cell overlap processor 205 which is coupled to the first transceiver 201. The cell overlap processor 205 is arranged to evaluate if any of the remote stations having the first cell as a serving cell is in a cell overlap region.

A cell overlap region may be any region wherein a handover to another cell may possibly be considered advantageous. Specifically, a cell overlap region may be a region where the conditions experienced by a remote station fall below a given quality level. The cell overlap processor 205 may specifically receive measurement reports and signal quality indications from the remote stations. This information may be evaluated to determine if improved performance may possibly be achieved by a handover to another cell. The assessment may be a relative and/or absolute evaluation. For example, it may be determined that the remote station is in a cell overlap region if the reported quality fails to meet a given quality requirement and/or if recorded measurement data for other cells indicate that these can better support the remote station. Thus, the cell overlap processor 205 can determine if the remote station is in a cell overlap region wherein the experienced conditions fail to meet a given criterion.

In the specific example of FIG. 1, the first remote station 101 is initially supported by the first base station 105 in only the first cell, i.e. only by the first transceiver 201. The first remote station 101 moves towards the edge of the cell formed by the first transceiver 201 and towards the cell formed by the second transceiver 203. At a given point in time, the cell overlap processor 205 detects that the first remote station 101 is approaching the edge of the first cell. In this region, the propagation conditions are such that the HSDPA service of the first remote station 101 cannot be efficiently supported by only the first transceiver 201. However, the first remote station 101 may still not be fully within the second cell and possibly cannot be efficiently supported by only the second transceiver 203 either.

For conversational services, the conventional HSDPA handover approach will result in significant delays and reduce the experienced quality of service. In contrast to the current approach for HSDPA, the first base station 105 comprises means for continuing the HSDPA downlink transmissions to the first remote station 101 using macro-diversity techniques.

Specifically, the first base station 105 comprises a macro-diversity controller 207 which is coupled to the first transceiver 201, the second transceiver 203 and the cell overlap processor 205. In addition, the macro-diversity controller 207 is coupled to an RNC interface 209 which is arranged to communicate with the first RNC 107. The RNC interface 209 receives the HSDPA data which is to be transmitted to the first remote station 101. This data is fed to the macro-diversity controller 207 which controls the HSDPA downlink transmissions of the first transceiver 201 and the second transceiver 203.

Specifically, if the first remote station is not in the cell overlap region as determined by the cell overlap processor 205, the macro-diversity controller 207 controls the first base station 105 such that the downlink packet data is transmitted only by the appropriate transceiver, i.e. in the specific example the first transceiver 201. The HSDPA data is specifically transmitted as packet data on the High Speed—Downlink Shared CHannel (HS-DSCH).

When the first remote station 101 enters the cell overlap region as detected by the cell overlap processor 205, the macro-diversity controller 207 controls the first base station 105 such that the HSDPA data is transmitted to the first remote station 101 as macro-diversity signals from both the first transceiver 201 and the second transceiver 203. Thus, in this example, the HSDPA downlink transmission to the first remote station 101 is on both the HS-DSCH of the first cell and the HS-DSCH of the second cell.

In a specific example, the macro-diversity controller 207 comprises an HSDPA scheduler that schedules the downlink data for both the first cell and the second cell. When scheduling data for the first remote station 101 when in the cell overlap region, a scheduling is performed such that the transmissions can be performed substantially simultaneously on the HS-DSCHs of the first and second cell.

The first remote station is arranged to receive the HSDPA data by combining the macro-diversity signals received in the first and second cell, i.e. both the signal transmitted by the first transceiver 201 and the signal transmitted by the second transceiver 203.

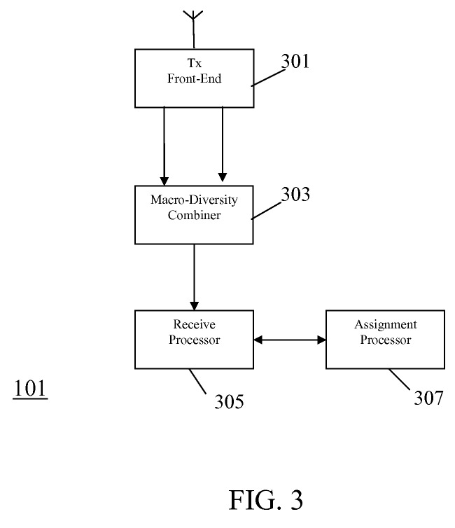

FIG. 3 illustrates the first remote station 101 in more detail. The first remote station 101 comprises a transceiver front-end 301 which is arranged to receive the signals from the first base station 105. The transceiver front-end 301 specifically generates a down-converted signal from the signals received from the first and second transceivers 201, 203. These signals are fed to a macro-diversity combiner 303 which combines the signals to a single signal. The macro-diversity combiner 303 may specifically perform soft combining, for example by use of the RAKE receiver as will be well known to the person skilled in the art. The combined signal is fed to a received processor 303 which generates the received HSDPA data.

Thus, the operation of the first base station 105 and the remote station 101 deviate from traditional HSDPA operation by using different communication techniques depending on whether the remote station is in a cell overlap region or not. Furthermore, the system allows use of macro-diversity techniques within an HSDPA framework.

As the operation changes depending on whether the remote station is in the cell overlap region, the macro-diversity controller 207 furthermore comprises means for transmitting an indication to the first remote station 101 that it is in the cell overlap region and therefore should change operation to take into account the signal transmitted from the second transceiver 203. This information may not only comprise an indication that combining of signals should be performed but may also indicate for example which cells should be included.

In some embodiments, the first base station 105 may transmit resource allocation assignments indicative of when HSDPA data for the first remote station is transmitted in both the first and second cell. However, in other embodiments, the allocation assignments are only transmitted in one of the cells and specifically are only transmitted by the serving cell.

The allocation assignments are transmitted on the High Speed—Shared Control CHannel (HS-SCCH) and in the example of FIG. 3, the first remote station 101 comprises an assignment processor 307 which decodes the HS-SCCH and controls the receive processor 305 in response to the assignment information. In some embodiments, the assignment processor 307 is arranged to only decode the HS-SCCH of the serving cell. This may reduce the complexity of the remote station 101.

In some embodiments, the HS-SCCH may be transmitted in a plurality of cells. Thus, the HS-SCCH may be transmitted using macro-diversity and the received signals from different cells may be combined in the remote station.

The macro-diversity controller 207 is in some embodiments arranged to ensure that the HSDPA downlink channels of the first and second transceiver 201, 203 are synchronised. Specifically, the HSPDA transmissions on different cells may be frame synchronised such that transmissions to a given remote station begin and end substantially simultaneously. Thus, in such embodiments, the framing of HS-SCCH and HS-DSCH transmissions in each cell of the first base station 105 are substantially synchronised thereby facilitating soft-combining in the first remote station 101.

In some embodiments, the first and second transceiver 201, 203 are arranged to use the same channelisation code for the HS-DSCHs of the first and second cell. Specifically, the channelisation code number used in the serving cell and the macro-diversity cell(s) can be the same. This may reduce the need to send any new information on the HS-SCCH to indicate additional channelisation codes. Another possibility is to use explicit signalling of codes which may provide a gain in resource allocation flexibility although at the cost of increasing signalling.

The above description has focussed on the use of intra-base station macro-diversity but in some embodiments, inter base station macro-diversity transmission may alternatively or additionally be used. Thus, HSDPA packets may be transmitted in macro-diversity when a remote station is in a region bordering two (or more) cells of different base stations. For example, in FIG. 1, the second remote station 103 may be in an overlap region between the first cell of the first base station 105 and a third cell supported by the second base station 109.

In such an example, much of the functionality described with reference to the macro-diversity controller 207 may be implemented in the first RNC 107. Specifically, the first RNC 107 may comprise functionality for transmitting the HSDPA data for the second remote station 103 to both the first base station 105 and the second base station 109 when the second remote station is in the cell overlap region.

In such a case, one of the cells may still be considered the serving cell for the HSDPA communication and the second remote station 103 may still only monitor the serving cell's HS-SCCH for assignments (in order to reduce complexity).

In the example, the first RNC 107 can perform the scheduling and can determine in what serving cell frame the macro-diversity transmission should be made. This frame number information can be added to the header of the HS-DSCH FP (Frame Protocol) that is transmitted down to each base site. Thus, the first RNC 107 can communicate a transmission time for HSPDA downlink transmission to the first and/or second base station.

Furthermore, the framing offset between cells is known to the RNC (for the purposes of timing conventional DCH transmissions). This framing offset information (offset between serving cell and non-serving cells) can be provided to one, more or all of the cells. Specifically, the framing offset with respect to the serving cell can be provided to the non-serving cells so that the HS-DSCH transmission in the non-serving cells is time aligned with that of the serving cell. Of course if all base sites are synchronised (e.g. through GPS) this may be used directly to synchronise the HSDPA downlink transmissions.

In an inter-base station macro-diversity transmission, the channelisation codes used in the serving cell and the non-serving cell(s) could be the same (in this way there would be no need to send any new information on the HS-SCCH to indicate additional channelisation codes). The RNC can indicate the channelisation code to be used in the HS-DSCH FP. As an alternative, to achieve more code allocation flexibility, different codes can be used in different cells but this will require additional signalling (though the information could all be transmitted on the HS-SCCH of just one cell).

Furthermore, the RNC may be allocated its own pool of HSDPA code resource which it can allocate in each cell. This may facilitate the allocation of resource for macro-diversity transmissions.

When a mobile station is involved in an HSDPA service, a number of control messages are transmitted from the mobile station to the base station supporting the HSDPA service. For example, the mobile station may transmit retransmission acknowledge messages (Hybrid ARQ ACK/NACK messages) and indications of the quality of the communication channel (CQI—Channel Quality Indicators). These messages are transmitted on a continuous HSDPA uplink control channel known as the HS-DPCCH (High Speed—Dedicated Physical Control CHannel).

Erroneous reception of HS-DPCCH may degrade the performance and efficiency of HSDPA services significantly. For example, retransmission acknowledgements/non-acknowledgements (ACK/NACKs) are transmitted on the HS-DPCCH and data errors may therefore affect the retransmission scheme resulting in reduced efficiency and increased resource consumption. Furthermore, Channel Quality Indications (CQI) used by HSDPA schedulers at the base station are also transmitted on the HS-DPCCH and errors in the CQIs may result in an inefficient scheduling. This may reduce capacity and degrade the quality of service.

In a macro-diversity HSDPA system, all the involved base stations receive the HS-DPCCH and hence the CQI and ACK/NACK information. The HS-DPCCH may be soft-combined in the base station(s) to provide a higher reliability of correctly receiving the uplink control information.

Furthermore, the determination of the receive quality indication CQI may be in response to a combination of received pilot signals from all the cells involved in the macro-diversity system rather than just from the serving cell as this may provide a more reliable indication of the actual receive quality experienced by the remote station.

Specifically, the CQI can be computed based on a macro-diverse combining of the Common PIlot CHannels (CPICH's) transmitted by the base sites involved in the macro-diversity transmissions. It should be noted that that the Primary-CPICH (P-CPICH) is always transmitted on the same spreading factor SF=256, 30 kbit/s channelisation code, though scrambling codes will be different in each cell, hence soft-combining is possible. The CQI can be computed based on a Measurement Power Offset (MPO) value as provided to the remote station and the involved base sites by the RNC. The MPO may for example be conveyed to the remote station on a signalling bearer mapped to the DCH, and hence delivered using macro-diversity operation. In addition, each base station involved in the macro-diversity operation can be provided with information of the pilot powers used in the other macro-diversity cells.

Since the base station has access to all information concerning MPO values, pilot powers, receive CQI etc it is able to compute appropriate power levels at which the HS-DSCH transmissions should be made in each cell. In inter-base station macro-diversity situations, the non-serving cells can receive information of pilot powers and MPO settings in the serving cell thereby allowing them to calculate suitable transmit power levels.

In inter-base station macro-diversity systems, it may become more complex to efficiently manage retransmission schemes. Accordingly, the system may be arranged to suspend HSDPA retransmission operations when the remote station is in the cell overlap region.

Furthermore, for inter-base station macro-diversity systems, the efficient combining of the received signals by the remote station is facilitated by the base stations using the same modulation scheme and channel coding. For example, a fixed modulation scheme/channel coding such as QPSK, ⅓ rate Viterbi coding may always be used.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims does not imply any specific order in which the features must be worked and in particular the order of individual steps in a method claim does not imply that the steps must be performed in this order. Rather, the steps may be performed in any suitable order.

1. A cellular communication system comprising:
first transmitting means for transmitting High Speed Downlink Packet Access, HSDPA, downlink packet data in a first cell;
second transmitting means for transmitting HSDPA downlink packet data in a second cell;
means for determining that a remote station is in a cell overlap region between the first cell and the second cell;
control means for causing the first transmitting means to transmit first HSDPA data to the remote station as a first signal in the first cell and the second transmitting means to transmit the first HSDPA data to the remote station as a second signal in the second cell, the first and second signals being macro-diversity signals; and
the remote station comprising combining means for receiving the first downlink HSDPA packet data by combining the first signal and the second signal.

2. The cellular communication system of claim 1 wherein the remote station is arranged to receive allocation assignments, and is arranged to decode a High Speed—Shared Control Channel (HS-SCCH), of only one of the first transmitting means and the second transmitting means.

3. The cellular communication system of claim 1 wherein the first transmitting means and the second transmitting means are part of a first base station, and further comprising means for frame synchronising at least one downlink channel of the first and second transmitting means used for transmissions to the remote station.

4. The cellular communication system of claim 1 wherein the remote station comprises means for determining a receive quality indication for the first HSDPA data in response to a combination of a received pilot signal of the first cell and a received pilot signal of the second cell.

5. The cellular communication system of claim 1 wherein the first transmitting means is part of a first base station and the second transmitting means is part of a second base station, and wherein the control means is part of a Radio Network Controller which comprises means for transmitting the first HSDPA data to both the first base station and the second base station when the remote station is in the cell overlap region.

6. The cellular communication system of claim 5 wherein the control means is arranged to communicate one of a transmission time and a channelisation code for the first signal to the first base station.

7. The cellular communication system of claim 5 wherein the control means is arranged to communicate a transmit frame offset between the first and second base station to at least one of the first and second base station.

8. The cellular communication system of claim 1 further comprising means for suspending a retransmission scheme when the remote station is in the cell overlap region.

9. The cellular communication system of claim 1 further comprising means for transmitting an indication to the remote station that the remote station is in the cell overlap region and wherein the combining means is arranged to combine the first signal and the second signal in response to the indication.

10. A method of communication in a cellular communication system, the method comprising
transmitting High Speed Downlink Packet Access, HSDPA, downlink packet data in a first cell;
transmitting HSDPA downlink packet data in a second cell;
determining that a remote station is in a cell overlap region between the first cell and the second cell;
causing the first transmitting means to transmit first HSDPA data to the remote station as a first signal in the first cell and the second transmitting means to transmit the first HSDPA data to the remote station as a second signal in the second cell, the first and second signals being macro-diversity signals; and
at the remote station receiving the first downlink HSDPA packet data by combining the first signal and the second signal.
